(19) United States
(12) Patent Application Publication
(10) Pub. No.: US 2022/0411607 A1
(43) Pub. Date: Dec. 29, 2022

(54) COATED ARAMID PULP FOR RUBBER REINFORCEMENT

(71) Applicant: BASF SE, Ludwigshafen (DE)

(72) Inventors: Charles O. Kerobo, Wyandotte, MI (US); John Andrew Randolph, Wyandotte, MI (US); Dennis Frederick Berry, Wyandotte, MI (US); Padma P. Varanasi, Wyandotte, MI (US)

(21) Appl. No.: 17/790,775

(22) PCT Filed: Jan. 5, 2021
(86) PCT No.: PCT/EP2021/050065

§ 371 Date: Jul. 5, 2022

Related U.S. Application Data
(60) Provisional application No. 62/958,449, filed on Jan. 8, 2020.

(30) Foreign Application Priority Data
May 8, 2020 (EP) 20173631.1

(51) Int. Cl. C08K 7/02; C08K 9/08; C08K 3/22; C08K 5/18; C08K 5/3472; C08K 5/14; C08K 5/01

(52) U.S. Cl. CPC C08K 7/02; C08K 9/08; C08K 3/22; C08K 5/18; C08K 5/3472; C08K 5/14; C08K 5/01; C08K 2003/2296

(57) ABSTRACT

The presently claimed invention relates to aramid pulp comprising a plurality of fibrils having a coating of polyalkyleneimine disposed thereon. The presently claimed invention further relates to a method of coating the aramid pulp with polyalkyleneimine. The presently claimed invention also relates to a rubber composition comprising the coated aramid pulp and rubber as well as to a method for preparing the rubber composition.

### TECHNICAL FIELD

The presently claimed invention relates to aramid pulp comprising a plurality of fibrils, said fibrils having a coating of polyalkyleneimine disposed thereon. The presently claimed invention further relates to a method of coating the aramid pulp comprising a plurality of fibrils with polyalkyleneimine. The presently claimed invention also relates to a rubber composition comprising the coated aramid pulp and rubber wherein said fibrils are dispersed in said rubber as well as to a method for preparing the rubber composition.

### BACKGROUND

Rubber is normally reinforced with a variety of fillers to improve their physical properties, such as stiffness and modulus. Inorganic particles like carbon black and/or silica are often augmented with fibers to improve the stiffness and modulus of the vulcanized rubber. Examples of such fibers are nylon, PET, polyesters, cellulose, aramid, cotton, etc. Depending on the application, these fibers could be continuous, chopped, or nonwoven. Optionally, these fibers may or may not undergo chemical treatment; the common chemical treatment used in these applications is Resorcinol Formaldehyde Latex (RFL). RFL have since been classified as a carcinogen. These fibers are either used by themselves or blended with other fiber types. For example, polyester chopped fiber can be used alone or in combination with another type such as cotton.

Fibrillated aramid pulps are generally fluffed to enlarge the unoriented aramid fibrils before incorporating into the rubber formulation. Optionally, aramid pulps are subjected to mechanical treatment to expose and enlarge the surface area of the pulp fibrils before use. Even with mechanical treatment, a great deal of difficulty of non-uniform dispersion is encountered when compounded into rubber.

To minimize the dispersion issues, those skilled in the art have used different methods to improve the dispersion of the aramid pulp in the rubber. For example, use of untreated aramid pulps by compounding the formulation through multiple cycles to improve the dispersion of the fibers. The number of blend cycles could be as high as five cycles. Passing the formulation through these cycles could be economically unsustainable, since one compounding cycle could take as much as 55 minutes depending on the batch size.

The other method employed to improve the dispersion of the aramid pulp in rubber is to use the pulp pre-blended into masterbatch by mixing the aramid pulp in polymer latex or other forms of polymers which are then incorporated in the formulation. Some compounders prefer these types since it shortens their mixing cycles and possible mixing time, but it adds cost of the raw material.

Another method reported in the prior art is the treatment of the aramid pulp with nanoparticles to ensure that the fibrils stay enlarged via the diffusion of the nanoparticles into the interstices of the fibrils. The nanoparticles could be in the form of silica, graphene, micronized pulp.

The mechanical method leads to non-uniform dispersion of the aramid pulp into the rubber. Other methods as mentioned above, aimed at minimizing the dispersion issues require additional step of preparing masterbatches and then incorporating them into rubber.

Thus, it is an object of the present invention to provide aramid pulp which can be incorporated directly into rubber and thus obviates the preparation of masterbatches. Another object is to provide aramid pulp which is evenly dispersed in the rubber matrix and enhances reinforcing of the rubber.

### SUMMARY OF THE INVENTION

Surprisingly, it has been found that coating the aramid pulp with a water-soluble cationic polymer is beneficial.

Thus, in one aspect, the presently claimed invention is directed to an aramid pulp comprising a plurality of fibrils, said fibrils having a coating of polyalkyleneimine disposed thereon.

In another aspect, the presently claimed invention relates to a method of coating the aramid pulp comprising a plurality of fibrils, said method comprising the steps of
(a) separating the plurality of fibrils to disentangle the fibrils;
(b) providing an aqueous solution of polyalkyleneimine;
(c) adding the aqueous solution of step (b) to the plurality of fibrils of step (a) and
(d) coating the plurality of fibrils with polyalkyleneimine to form coated aramid pulp.

In another aspect, the presently claimed invention relates to a rubber composition based on parts by weight per 100 parts by weight rubber (phr), comprising
(a) 1 to 25 phr of coated aramid pulp; and
(b) rubber;
wherein said fibrils are dispersed in said rubber.

In another aspect, the presently claimed invention relates to a method for preparing a rubber composition comprising the steps of
(i) providing the coated aramid pulp as defined above;
(ii) dispersing the coated fibrils of the aramid pulp of step (i) into rubber to form a rubber mixture;
(iii) combining the rubber mixture of step (ii) with at least one curative agent; and
(iv) curing the rubber mixture.

In another aspect, the presently claimed invention relates to the use of the rubber composition as defined above, in conveyor belts, power transmission belts, seals, gaskets, tires or stator pump components.

In still another aspect, the presently claimed invention relates to a conveyor belt, power transmission belt, seals, gaskets, tires or stator pump components comprising the rubber composition as defined above.

### BRIEF DESCRIPTION OF THE DRAWINGS

Other advantages of the present invention will be readily appreciated, as the same becomes better understood by reference to the following detailed description when considered in connection with the accompanying drawings.

FIG. 1(a) is a Brightfield reflected polarized light microscope images of uncoated rubber of comparative example 1.

FIG. 1(b) is a Brightfield reflected polarized light microscope images of rubber with aramid pulp coated with polyethyleneimine of example 7 at 50× magnification. A clump of aramid pulp not dispersed is visible in the case of FIG. 1(a) whereas in the case of FIG. 1(b) the dispersion of aramid pulp in the rubber matrix is even.

FIG. 2(a) is a cross-section of a rubber sample at 200× magnification using variable-pressure backscattered electron (VP-BSE) imaging of uncoated rubber of comparative example 1.

FIG. 2(b) is a cross-section of a rubber sample at 200× magnification using variable-pressure backscattered electron (VP-BSE) imaging of rubber with aramid pulp coated with polyethyleneimine of example 7.

FIG. 3 is a Brightfield reflected light microscope image of cryo-ultramicrotomed vulcanized rubber sample at −100° C., block face surface showing aramid pulp fibers embedded in the rubber matrix of comparative example 1. Boxed areas indicate where atomic force microscopy (AFM) scans were performed (see FIGS. 4-6).

FIG. 4(a) is a TappingMode™ AFM Height image at 10 um×10 um scan area at interface of pulp fiber and rubber matrix of comparative example 1 shown in FIG. 3.

FIG. 4(b) is a TappingMode™ AFM Phase image at 10 um×10 um scan area at interface of pulp fiber and rubber matrix of comparative example 1 shown in FIG. 3.

FIG. 4(c) is a 3-D Height image of comparative example 1 shown in FIG. 3, which shows a valley formed from lack of adhesion at the interface. Z-scale for 3-D Height image is 1 um, tilt=45 degrees, rotation=15 degrees.

FIG. 5(a) is a TappingMode™ AFM Height image at 25 um×25 um scan area at the interface of pulp fiber and rubber matrix of comparative example 1 shown in FIG. 3.

FIG. 5(b) is a TappingMode™ AFM Phase image at 25 um×25 um scan area at the interface of pulp fiber and rubber matrix of comparative example 1 shown in FIG. 3.

FIG. 5(c) is a 3-D Height image of comparative example 1 shown in FIG. 3, which shows a valley formed from a lack of adhesion at the interface. Z-scale for 3-D Height image is 1 um, tilt=45 degrees, rotation=15 degrees.

FIG. 6(a) is a TappingMode™ AFM Height image at 10 um×10 um scan area at the interface of pulp fiber and rubber matrix of comparative example 1 shown in FIG. 3.

FIG. 6(b) is a TappingMode™ AFM Phase image at 10 um×10 um scan area at the interface of pulp fiber and rubber matrix of comparative example 1 shown in FIG. 3.

FIG. 6(c) is a 3-D Height image of the interface of pulp fiber and rubber matrix of comparative example 1 shown in FIG. 3, which shows a valley formed from a lack of adhesion at the interface. Z-scale for 3-D Height image is 1 um, tilt=45 degrees, rotation=15 degrees.

FIG. 7 is a Brightfield reflected light microscope image of cryo-ultramicrotomed vulcanized rubber sample at −100° C., block face surface showing aramid pulp fibers embedded in the rubber matrix of example 7. Boxed areas indicate where AFM scans were performed (see FIGS. 8-12).

FIG. 8(a) is a TappingMode™ AFM Height image of the interface between polyethyleneimine coated pulp fiber and rubber matrix of example 7.3 um×3 um scan was taken from the area shown in FIG. 7.

FIG. 8(b) is TappingMode™ AFM Phase image of the interface between polyethyleneimine coated pulp fiber and rubber matrix of example 7.3 um×3 um scan was taken from the area shown in FIG. 7.

FIG. 9(a) is a TappingMode™ AFM Height image at 10 um×10 um scan area at the interface of pulp fiber and rubber matrix shown in FIG. 7.

FIG. 9(b) is TappingMode™ AFM Phase image at 10 um×10 um scan area at the interface of pulp fiber and rubber matrix shown in FIG. 7.

FIG. 9(c) is a 3-D Height image of the interface of pulp fiber and rubber matrix shown in FIG. 7, which shows a uniform transition from pulp to rubber matrix at their interface, for rubber with aramid pulp coated with polyethyleneimine. Z-scale for 3-D Height image is 1 um, tilt=45 degrees, rotation=15 degrees.

FIG. 10(a) is a TappingMode™ AFM Height image at 10 um×10 um scan area at the interface of pulp fiber and rubber matrix for rubber with aramid pulp coated with polyethyleneimine of example 7.

FIG. 10(b) is a TappingMode™ AFM Phase image at 10 um×10 um scan area at the interface of pulp fiber and rubber matrix for rubber with aramid pulp coated with polyethyleneimine of example 7.

FIG. 10(c) is a 3-D Height image of the interface of pulp fiber and rubber matrix for rubber with aramid pulp coated with polyethyleneimine of example 7, which shows a uniform transition from pulp to rubber matrix at their interface. Z-scale for 3-D Height image is 1 um, tilt=45 degrees, rotation=15 degrees.

FIG. 11(a) is a TappingMode™ AFM Height image of the interface between polyethyleneimine coated pulp and rubber matrix for rubber of example 7.3 um×3 um scan was taken from the area shown in FIG. 7.

FIG. 11(b) is a TappingMode™ AFM Phase image of the interface between polyethyleneimine coated pulp and rubber matrix for rubber of example 7.3 um×3 um scan was taken from area shown in FIG. 7.

FIG. 12(a) is TappingMode™ AFM Height image of the interface between polyethyleneimine coated pulp and rubber matrix for rubber of example 7.1 um×1 um scan was taken from the area shown in FIG. 7.

FIG. 12(b) is a TappingMode™ AFM Phase image of the interface between polyethyleneimine coated pulp and rubber matrix for rubber of example 7.1 um×1 um scan was taken from rhw area shown in FIG. 7.

### DETAILED DESCRIPTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the presently claimed invention. Thus, appearances of the phrases “in one embodiment” or “in an embodiment” or “in another embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Thus, in one aspect, the presently claimed invention is directed to an aramid pulp having a coating of polyalkyleneimine disposed thereon.

Aramid Pulp

Aramids are typically formed by reacting amines and carboxylic acid halides. In one embodiment, the aramid is further defined as having at least about 85 percent of amide linkages (—CO—NH—) attached directly to two aromatic rings. The aramid may be any known aramid in the art, but is typically further defined as an AABB polymer, sold under tradenames such as NOMEX®, KEVLAR®, TWARON® and/or NEW STAR™. As is well known in the art, NOMEX® and NEW STAR™ include predominantly meta-linkages and are typically further defined as poly-metaphenylene isophthalamides. KEVLAR® and TWARON® are both para-phenylene terephthalamides (PPTA), the simplest form of an AABB para-polyaramide. PPTA is a product of p-phenylene diamine (PPD) and terephthaloyl dichloride (TDC or TCI). Alternatively, the aramid may be further defined as the reaction product of PPD, 3,4′-diaminodiphenylether, and terephthaloyl chloride (TCI).

By the term ‘pulp’ it is meant as a highly fibrillated fiber product that is manufactured from yarn by chopping into staple followed by mechanically abrading in water to partially shatter the fibers. In the case of aramid pulp, the particles of aramid material have stalk and fibrils extending therefrom wherein the stalk is generally columnar and about 10 to 50 microns in diameter and the fibrils are hair-like members, only a fraction of a micron or a few microns in diameter attached to the stalk and about 10 to 100 microns long.

Aramid fibers are converted into aramid pulp to give a large increase in surface area as fibrils with diameters as low as 0.1 micrometer are attached to the surface of the main fibers, which are typically 12 micrometers in diameter. Typically, para-aramid pulp has a specific surface area of from 7 to 11 m²/g although values in the range of 4.2 to 15 m²/g have been reported.

In an embodiment, an aramid pulp comprises a plurality of fibrils.

By the term ‘fibrils’ it is meant that the aramid pulp is highly fibrillated having length of 0.5-1 mm and a bulk density in the range of 3-10 lb/ft³.

In an embodiment, the aramid pulp has a weight average molecular weight of 10,000 g/mol to 40,000 g/mol, determined according to gel permeation chromatography.

In an embodiment, the coated aramid pulp is optionally blended with micronized aramid pulp. Micronized pulp is prepared by grinding the aramid pulp such that it has fine particles. The micronized pulp is prepared by grinding the coated aramid pulp or uncoated aramid pulp or mixture thereof.

Polyalkyleneimine

In an embodiment, the aramid pulp comprises a plurality of fibrils, said fibrils having a coating of polyalkyleneimine disposed thereon.

In an embodiment, the polyalkyleneimine has primary amines, secondary amines and tertiary amines in a weight ratio of 1:0.9:0.5 to 1:1.1:0.7.

Polyalkyleneimines may bear substituents at primary or secondary N-atoms of the backbone polyalkyleneimine. In an embodiment, the primary and secondary amino groups of the polyalkyleneimine can be functionalized with either hydrophobic or hydrophilic moiety or both hydrophobic and hydrophilic moieties. Suitable substituents are polyethylene oxide chains such as, but not limited to, polyethylene oxide chains and polypropylene oxide chains and mixed polyalkylene oxide chains. Further examples of substituents are CH₂COOH groups, as free acids or partially or fully neutralized with alkali. Polyalkyleneimine bearing one or more of the foregoing substituents is hereinafter also referred to as substituted polyalkyleneimine.

In an embodiment, the polyalkyleneimine is non-substituted.

In an embodiment, the at least one polyalkyleneimine is a polyethyleneimine of the general formula (1).

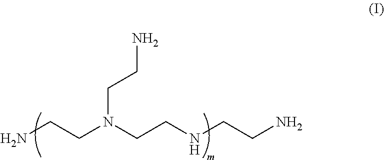

wherein m is an integer in the range of from 10 to 1000.

In an embodiment, the polyethyleneimine has a nitrogen to carbon ratio of 1:2.

In an embodiment, the at least one polyethyleneimine has a weight average molecular weight of 800 g/mole to 2,000,000 g/mole. The weight average molecular weight (Mw) is determined by gel permeation chromatography (GPC), with 1.5% by weight aqueous formic acid as eluent and cross-linked poly-hydroxyethyl methacrylate as stationary phase.

The at least one polyethyleneimine is prepared according to methods known in the art. For example, aziridine is cationically polymerized to form polyethyleneimines in the presence of an acidic catalyst.

In another aspect, the presently claimed invention relates to a method of coating the aramid pulp comprising the steps of
(a) separating the plurality of fibrils to disentangle the fibrils;
(b) providing an aqueous solution of polyalkyleneimine;
(c) adding the aqueous solution of step (b) to the plurality of fibrils of step (a) and
(d) coating the plurality of fibrils with polyalkyleneimine to form coated aramid pulp.

By the term ‘coating’ it is meant that the polyalkyleneimine is deposited on the aramid pulp evenly and completely. The polyalkyleneimine is normally bound to the aramid pulp via physisorption like adhesion.

An ‘aqueous solution’ means that the polyalkyleneimine is completely or partly dissolved in water. In an embodiment, the aqueous solution is a clear solution without any turbidity.

In another embodiment, the solution comprises the polyalkyleneimine at least partly in dissolved state but shows turbidity. In a preferred embodiment, the solution comprising the polyalkyleneimine is clear. ‘Clear’ herein refers to the clarity observed visually.

In an embodiment, the weight ratio of amount of aramid pulp to aqueous solution of polyalkyleneimine is in the range of 1:1 to 1.5:1.

Step (a) of separating the plurality of fibrils to disentangle the fibrils can be done in a mixer. Separating the fibrils increases the surface area and leads to an improved distribution of polyalkyleneimine on the aramid pulp such that the polyalkyleneimine is evenly coated on the aramid pulp.

Step (a) of separating the plurality of fibrils to disentangle the fibrils can be done in any mixer, such as, for example a plowshare mixer. The plowshare mixer in addition to chopper may additionally be fitted with a “stars and bars” stack.

In an embodiment, step (a) is carried out at a temperature in the range of 50° C. to 150° C.

In an embodiment, in step (b) the aqueous solution comprises polyethyleneimine in the range of 1% to 20% by weight.

In another embodiment, in step (b) the aqueous solution comprises polyethyleneimine in the range of 3% to 17% by weight.

The aqueous solution of polyethyleneimine, for example 20% by weight, is prepared by adding 20 g of polyethyleneimine to 100 ml water.

In an embodiment, in step (c) the aqueous solution of polyalkyleneimine is deposited onto the plurality of fibrils.

In an embodiment, the aqueous solution of polyethyleneimine is sprayed onto the dispersed aramid pulp.

In an embodiment, the aqueous solution of polyethyleneimine is sprayed onto the dispersed aramid pulp under nitrogen.

In another embodiment, the aqueous solution of polyalkyleneimine is sprayed onto the dispersed aramid pulp at a rate of 90 ml/minute to 120 ml/minute.

In an embodiment, the aqueous solution of polyethyleneimine is sprayed onto the dispersed aramid pulp by means of a spray nozzle.

In an embodiment, the aqueous solution of polyethyleneimine is sprayed onto the dispersed aramid pulp by means of an LNN-1 type spray nozzle.

In an embodiment, spraying of the aqueous solution of polyalkyleneimine is carried out at a temperature in the range of 50° C. to 150° C.

In an embodiment, spraying of the aqueous polyalkyleneimine solution over the fibrils is affected in the mixer itself while the pulp is being mixed. This leads to a uniform coating of the polyalkyleneimine on the fibrils of the aramid pulp.

In an embodiment, vacuum is applied when one half of the aqueous polyalkyleneimine solution is sprayed onto the fibrils.

In an embodiment, the method of coating aramid pulp comprising a plurality of fibrils further comprises a step (e) of drying the coated aramid pulp of step (d).

In an embodiment, step (e) of drying is carried out at a temperature of 40° C. to 150° C.

In an embodiment, step (e) of drying is carried out by optionally subjecting the coated aramid pulp to vacuum of 20 mmHg to 40 mm Hg at a temperature of 40° C. to 150° C.

In an embodiment, step (e) of drying is carried out by optionally providing nitrogen into the mixer to drive off moisture.

The coated aramid pulp can be used as a potential replacement for asbestos used in insulation material.

Rubber Composition

In another aspect, the presently claimed invention relates to a rubber composition based on parts by weight per 100 parts by weight rubber (phr), comprising
(c) 1 to 25 phr of coated aramid pulp; and
(d) rubber;
wherein said fibrils are dispersed in said rubber.

The term ‘phr’ as used herein, and according to conventional practice, refers to ‘parts by weight of a respective material per 100 parts by weight of rubber’.

In an embodiment, the amount of coated aramid pulp is in the range of 3 phr to 20 phr.

In an embodiment, the amount of coated aramid pulp is in the range of 5 phr to 15 phr.

Rubber

In an embodiment, the rubber is selected from natural rubber, synthetic rubber and blends thereof. Various non-limiting examples of suitable rubber include natural rubber (natural polyisoprene), synthetic polyisoprene, polybutadiene, chloroprene rubber, butyl rubber, halogenated butyl rubber, styrene-butadiene rubber, nitrile rubber, ethylene propylene rubber, ethylene propylene diene rubber (EPDM), epichlorohydrin rubber, polyacrylic rubber, silicone rubber, fluorosilicone rubber, fluoroelastomer, perfluoroelastomer, polyether block amides, chlorosulfonated polyethylene, and ethylene-vinyl acetate. Mixtures of rubbers may also be utilized.

Additive

In an embodiment, the rubber composition of the presently claimed invention further comprises at least one additive.

In an embodiment, the at least one additive is selected from curatives, accelerants, anti-oxidants, retarders, processing additives, plasticizers, chain terminators, adhesion promoters, flame retardants, dyes, ultraviolet light stabilizers, fillers, acidifiers, and catalysts.

In an embodiment, the curative is selected from sulfur, peroxide, metallic oxide, urethane crosslinkers, acetoxysilane, and mixtures thereof. Examples of peroxides are dicumyl peroxide, 2,5-dimethyl-2,5-di-t-butylperoxyhexane, p-quinone dioxime.

In an embodiment, the accelerants are selected from thioureas, thiophenols, mercaptans, di-thiocarbamates, xanthates, trithiocarbonates, dithio acids, mercaptothiazoles, mercaptobenzothiazoles, thiuram sulfides, for example N,N′-1,3-Phenylene bismaleimide, N-tert-butyl-2-benzothiazolylsulfenamide (TBBS), N-cyclohexyl-2-benzothiazolylsulfenamide (CBS), N,N-dicyclohexyl-2-benzothiazolylsulfenamide (DCBS), and N,N-diisopropyl-2-benzothiazole sulfenamide (TBSI).

In an embodiment, the antioxidants are selected from 4,4′-Bis (alpha, alpha-dimethylbenzyl) diphenylamine, zinc 2-mercaptotolumidazole, phenylbeta-naphthylamine, p-amino-phenol, hydroquinone, diphenylamine, 2,4-n-toluylene diamine, p-ditolylamine, o-ditolylamine, beta-naphthyl-nitroso amine, diphenyl diamino-ethane, phenyl-alpha-naphthyl amine and p,p′-diamino-diphenylmethane.

In an embodiment, the retaders are selected from N-nitroso diphenyl amine, rosin, salicyclic acid, zinc salts of aliphatic substituted benzene sulfonic acids and aliphatic sulfuric acids.

In an embodiment, the processing additives are selected from tar, oil, fatty acids or their salts. Examples of oils are paraffinic oils, aromatic type oils, and naphthenic oils. In an embodiment, the oil is treated distillate aromatic extracts, also known as TDAE. In an embodiment, the oil is paraffinic oil. Examples of fatty acids are, but not restricted to, C₁₁-C₃₁-alkyl carboxylic acids and C₁₁-C₃₁-alkenyl carboxylic acids, for example with one, two or three C—C double bond(s) per molecule. Specific examples are oleic acid, stearic acid and palmitic acid and their respective salts. In one embodiment, inventive rubber compositions contain in the range of from 0.1 to 20% by weight fatty acid(s) or their salts. Suitable counterions are Zn²⁺, NH₄⁺, Ca²⁺ and Mg²⁺.

In an embodiment, the plasticizers are selected from paraffinic, aromatic, naphthenic extender oils; polar plasticizers such as monomeric phthalates, such as dioctyl phthalate, DINB, DIDP, or DBP; monomeric adipates or sebacates; and polyester adipates or sebacates; and mixtures thereof.

In an embodiment, the adhesion promoters are selected from neoalkoxy zirconate with an organo-phosphate group, such as neopentyl-diallyl-oxy tri-dioctylphosphato zirconate

In an embodiment, the flame retardants are for example, but not restricted to, a chlorine-based aliphatic compounds such as chlorinated paraffins, chlorine-based phosphorus compounds such as a chlorine-based phosphate ester compounds, chlorinated aliphatic compounds, chlorinated paraffins, N,N′-ethylene-bis (tetrabromophthalimide) or N,N′-bis(tetrabromophthalimide).

In an embodiment, ultraviolet light stabilizers are selected from 2-(2′-hydroxyphenyl)-benzotriazoles, for example, the 5′-methyl-,3′ 5′-di-tert-butyl-,5′-tert-butyl-,5′ (1,1,3,3-tetramethylbutyl)-, 5-chloro-3′,5′-di-tert-butyl-,5-chloro-3′-tert-butyl-5′-methyl-3′-sec-butyl-5′-tert-butyl-,4′-octoxy,3′,5′-ditert-amyl-3′,5′-bis-(alpha, alpha.-dimethylbenzyl)-derivatives, 2-hydroxy-benzophenones, for example, the 4-hydroxy-4-methoxy-, 4-octoxy, 4-decyloxy-, 4-dodecyloxy-,4-benzyloxy,4,2′,4′-trihydroxy- and 2′-hydroxy-4,4′-dimethoxy derivative, esters of substituted and unsubstituted benzoic acids for example, phenyl salicylate, 4-tertbutylphenyl-salicylate, octylphenyl salicylate, dibenzoylresorcinol, bis-(4-tert-butylbenzoyl)-resorcinol, benzoyl resorcinol, 2,4-di-tert-butyl-phenyl-3,5-di-tert-butyl-4-hydroxybenzoate and hexadecyl-3,5-di-tert-butyl-4-hydroxybenzoate. Acrylates, for example, alpha-cyano-beta, beta-diphenylacrylic acid-ethyl ester or isooctyl ester, alpha-carbomethoxy-cinnamic acid methyl ester, alpha-cyano-beta-methyl-p-methoxy-cinnamic acid methyl ester or butyl ester, alpha-carbomethoxy-p-methoxy-cinnamic acid methyl ester, N-(beta-carbomethoxy-beta-cyano-vinyl)-2-methyl-indoline may be used as UV absorbers and light stabilizers.

Sterically hindered amines may be used as UV absorbers and light stabilizers as for example bis (2,2,6,6-tetramethylpiperidyl)-sebacate, bis-5 (1,2,2,6,6-pentamethylpiperidyl)-sebacate, n-butyl-3,5-di-tert-butyl-4-hydroxybenzyl malonic acid bis(1,2,2,6,6,-pentamethylpiperidyl)ester, condensation product of 1-hydroxyethyl-2,2,6,6-tetramethyl-4-hydroxy-piperidine and succinic acid, condensation product of N,N′-(2,2,6,6-tetramethylpiperidyl)-hexamethylendiamine and 4-tert-octylamino-2,6-dichloro-1,3,5-s-triazine, tris-(2,2,6,6-tetramethylpiperidyl)-nitrilotriacetate, tetrakis-(2,2,6,6-tetramethyl-4-piperidyl)-1,2,3,4butane-tetra-arbonic acid, 1,1′(1,2-ethanediyl)-bis-(3,3,5,5-tetramethylpiperazinone). These amines typically called HALS (Hindered Amines Light Stabilizers) include butane tetracarboxylic acid 2,2,6,6-tetramethyl piperidinol esters. Such amines include hydroxylamines derived from hindered amines, such as di(1-hydroxy-2,2,6,6-tetramethylpiperidin-4-yl) sebacate: 1-hydroxy 2,2,6,6-tetramethyl-4-benzoxypiperidine; 1-hydroxy-2,2,6,6-tetramethyl-4-(3,5-di-tert-butyl-4-hydroxy hydrocinnamoyloxy)-piperdine; and N-(1-hydroxy-2,2,6,6-tetramethyl-piperidin-4-yl)-epsiloncaprolactam.

UV light stabilizers may also comprise oxalic acid diamides, for examples, 4,4′-di-octyloxy-oxanilide, 2,2′-di-octyloxy-5′,5′-ditert-butyloxanilide, 2,2′-di-dodecyloxy-5′,5′ di-tert-butyl-oxanilide, 2-ethoxy-2′-ethyl-oxanilide, N,N′-bis(3-dimethylaminopropyl)-oxalamide, 2-ethoxy-5-tert-butyl-2′-ethyloxanilide and its mixture with 2-ethoxy-2′-ethyl-5,4-di-tert-butyloxanilide and mixtures of ortho- and para-methoxy-as well as of o- and p-ethoxy-disubstituted oxanilides.

UV light stabilizers may comprise hydroxyphenyl-s-triazines, as for example 2,6-bis-(2,4-dimethylphenyl)-4-(2-hydroxy-4octyloxyphenyl)-s-triazine, 2,6-bis(2,4-dimethylphenyl)-4-(2,4-dihydroxyphenyl)-s-triazine, 5 2,4-bis(2,4-dihydroxyphenyl)-6-(4-chlorophenyl)-s-triazine; 2,4-bis(2-hydroxy-4-(2-hydroxyethoxy)phenyl)-6-(4-chlorophenyl)-s-triazine; 2,4-bis(2hydroxy-4-(2-hydroxyethoxy)phenyl)-6-phenyl-s-triazine; 2,4-bis(2-hydroxy-4-(2-hydroxyethoxy)-phenyl)-6-(2,4-dimethylphenyl)-s-triazine; 2,4-bis(2-hydroxy-4-(2-hydroxyethoxy)phenyl)-6-(4-bromo-phenyl)-s-triazine; 2,4-bis(2-hydroxy-4-(2-acetoryethoxy)phenyl)-6-(4-chlorophenyl)-s-triazine, 2,4-bis(2,4-dihydroxyphenyl)-6-(2,4-dimethylphenyl)-1-s-triazine.

In an embodiment, the filler is carbon black. In another embodiment, the filler is a mineral filler selected from zinc oxide, silicates such as synthetic silicates and natural silicates such as kaolin, calcium carbonate, magnesium oxides, magnesium carbonate, zinc carbonate, clay, titanium dioxide, talc, gypsum, alumina, bentonite, and kaolin.

In order to initiate the curing, sulphur may be added to the rubber composition. One or more sulphur compounds such as zinc diethyldithiocarbamate, zinc ethyl phenyl dithiocarbamate, dimethyldiphenyl thiuramdisulfide, zinc dibutyldithiocarbamate, dibenzodiazyldisulfide, zinc dibenzyl dithiocarbamate, tetramethylthiuram disulfide (CH₃)₂N—C(═S)—S—S—C(═S)—N(CH₃)₂, or 1,3-benzothiazol-2-thiol, may be added as well. Further examples of suitable vulcanization accelerators are xanthogenates, toluidines and anilines. Vulcanization accelerators may be applied as such or together with an activator such as ZnS or Sb₂S₃ or PbO.

In an embodiment, the amount of the at least on additive is in the range of 50 phr to 85 phr.

Method for Preparation of Rubber Composition

In an aspect, the presently claimed invention is directed to a method for preparing a rubber composition comprising the steps of:
(i) providing the coated aramid pulp;
(ii) dispersing the coated fibrils of the aramid pulp of step (i) into rubber to form a rubber mixture;
(iii) combining the rubber mixture of step (ii) with at least one curative agent; and
(iv) curing the rubber mixture.

The rubber composition of the presently claimed invention can be prepared in a mixer.

In an embodiment, the mixing may be a two-stage mixing process. In the first stage, additives such as processing oil, anti-oxidants and filler are added in the first pass.

In an embodiment, the batch temperature in the first stage may be in the range of 30° C. to 150° C.

In an embodiment, the additives such as curative agent peroxide and accelerator are mixed with the master batch in the final (productive) pass.

In an embodiment, the batch temperature in the final stage may be in the range of 30° C. to 150° C.

Cure rate information (MDR rheometer data) are determined according to ASTM D 5289-17 using moving die rheometer (Tech Pro rheoTECH MDR, 0.5° arc, 170° C.). Rubber samples are compression molded with curing temperature equal to 170° C. and molding time equal to 15 minutes for test plaques and 20 minutes for compression set buttons, abrasion specimens, and crack growth specimens. The samples are then post-cured in an air oven for 2 hours at 149° C. MDR rheometer data is measured for theTc90 and Ts1. Tc90 is the time it takes for a compound to reach 90 percent of its total state of cure or crosslinks and Ts1 is the time it takes for the viscosity to rise 1 point over the Minimum Torque (ML) value. This is an indication of the time it takes for the compound to begin curing up at the specified temperature. Ts1 can indicate compound shelf life and stability and can help determine if there is enough time to injection or transfer mold.

Physical properties of the compounds are tested for tensile strength, elongation and durometer. Tensile Strength at Break and Elongation at Break are tested according to the test method ASTM D412-15a, D2240-15 Durometer are measured as directed in ASTM D 2240-15E1, type A [15].

Viscoelastic properties are examined using dynamic mechanical analysis (DMA) according to ASTM D 5992-96 (2011) [19]. Storage modulus (E′), loss modulus (E″) and tan δ data are obtained through strain sweeps in tension at 30° C. with frequency equal to 1 Hz using a Metravib DMA 150 Dynamic Mechanical Analyzer. Payne Effect and Mullins effect values are calculated from the storage modulus and loss modulus. The Payne effect is the drop in E′ as the dynamic strain is increased. The Payne effect is attributed to the filler-filler interaction, the breaking and recovery of weak physical bonds linking adjacent filler particles. The Mullins Effect is a measure of the dynamic stress-softening that is observed between the first and second strain sweeps due to the polymer-filler matrix being pulled apart during the first strain sweep and not having time to re-agglomerate.

A dispersion analysis is performed using a Nanotronics nSpec 3D. A topography scan was performed using a 10× Objective and scan settings of ΔZ=0.5 and Model=0.4. The 3D model is flattened after the scan.

In another aspect, the presently claimed invention relates to the use of the rubber composition as defined above, in conveyor belts, power transmission belts, seals, gaskets, tires or stator pump components.

In still another aspect, the presently claimed invention relates to a conveyor belt, power transmission belt, seals, gaskets, tires or stator pump components comprising the rubber composition as defined above.

The presently claimed invention offers one or more of following advantages:
1. Polyalkyleneimine being cationic water-soluble polymers, mitigate the electrostatic charges of the aramid pulp and therefore render the pulp dust-free which essentially eliminates the dust particles encountered in the use of these type of reinforcing material.
2. Coated Aramid pulps are better reinforcing in the rubber matrix as indicated by the higher modulus (stiffness) compared to the uncoated pulps.
3. The coated Aramid pulps, at lower fiber content (10 phr), have similar with-grain & against-grain tensile strength at break compared to the uncoated higher pulp content (15 phr).

List of Reference numerals

| | |
|---|---|
| 1 | Aramid pulp |
| 2 | Rubber matrix |
| 3 | Pull away |
| 4 | No pull away |
| 5 | polyethylenimine |
| 6 | Slight gap |
| 7 | No gap |

In the following, specific embodiments of the presently claimed invention are described:
1. Aramid pulp comprising a plurality of fibrils, said fibrils having a coating of polyalkyleneimine disposed thereon.
2. The coated aramid pulp according to embodiment 1, wherein the aramid pulp has a weight average molecular weight of 10,000 g/mol to 40,000 g/mol.
3. The coated aramid pulp according to embodiment 1, wherein the polyalkyleneimine has primary amines, secondary amines and tertiary amines in a weight ratio of 1:0.9:0.5 to 1:1.1:0.7.
4. The coated aramid pulp according to embodiment 1, wherein the polyalkyleneimine is polyethyleneimine.
5. The coated aramid pulp according to embodiment 4, wherein the polyethyleneimine has a weight average molecular weight of 800 g/mole to 2,000,000 g/mole.
6. The coated aramid pulp according to embodiment 4 or 5, wherein the polyethyleneimine has a nitrogen to carbon ratio of 1:2.
7. A method of coating aramid pulp comprising a plurality of fibrils, said method comprising the steps of
   (a) separating the plurality of fibrils to disentangle the fibrils;
   (b) providing an aqueous solution of polyalkyleneimine;
   (c) adding the aqueous solution of step (b) to the plurality of fibrils of step (a); and
   (d) coating the plurality of fibrils with polyalkyleneimine to form coated aramid pulp.
8. The method according to embodiment 7, further comprising a step (e) of drying the coated aramid pulp.
9. The method according to embodiment 7, wherein step (a) is carried out in a mixer.
10. The method according to embodiment 9, wherein the mixer is a plough shear mixer.
11. The method according to embodiment 7, wherein the aqueous solution comprises polyethyleneimine in the range of 1% to 20% by weight based on the total weight of the aqueous solution.
12. The method according to claim 8, wherein step (e) drying is carried out at a temperature of 50° C. to 150° C.
13. A rubber composition, based on parts by weight per 100 parts by weight rubber (phr), comprising:
   (a) 1 to 25 phr of coated aramid pulp according to one or more of embodiments 1 to 6; and
   (b) rubber
   wherein said fibrils are dispersed in said rubber.
14. The rubber composition according to embodiment 13, wherein the rubber is selected from natural rubber, synthetic rubber and blends thereof.
15. The rubber composition according to embodiment 13 or 14, wherein the amount of coated aramid pulp is in the range of 3 phr to 20 phr.
16. The rubber composition according to one or more of embodiments 13 to 15, wherein the amount of coated aramid pulp is in the range of 5 phr to 15 phr.
17. The rubber composition according to one or more of embodiments 13 to 16, further comprising at least one additive.
18. The rubber composition according to embodiment 17, wherein the at least one additive is selected from curatives, accelerants, anti-oxidants, retarders, processing additives, plasticizers, chain terminators, adhesion promoters, flame retardants, dyes, ultraviolet light stabilizers, fillers, acidifiers, and catalysts.
19. A method for preparing a rubber composition comprising the steps of:
   (i) providing the coated aramid pulp according to one or more of embodiments 1 to 6;
   (ii) dispersing the coated fibrils of the aramid pulp of step (i) into rubber to form a rubber mixture;
   (iii) combining the rubber mixture of step (ii) with at least one curative agent; and
   (iv) curing the rubber mixture.
20. The method according to embodiment 19, wherein the amount of coated aramid pulp is in the range of 5 phr to 15 phr.
21. The method according to embodiment 19, wherein the curative agent is selected from sulfur, peroxide, metallic oxide, urethane crosslinkers, acetoxysilane, and mixtures thereof.
22. Use of the rubber composition according to one or more of embodiments 13 to 18 in technical applications.
23. Use of the rubber composition according to embodiment 13 to 18 in conveyor belts, power transmission belts, seals, gaskets, tires or stator pump components.
24. A conveyor belt, power transmission belt, seals, gaskets, tires or stator pump components comprising the composition according to one or more of embodiments 13 to 18.

### EXAMPLES

Compounds

Aramid Pulp

Royalene 580-HT (EPDM with Mooney viscosity of 60 (ML (1+4100°) C (milled)=60) with 53/47 ratio of Ethylene to Propylene and 2.7% ENB content)

Filler A is carbon black.

Additive A is paraffinic oil.

Additive B is zinc oxide.

Additive C is an antioxidant comprising 4,4′-Bis (alpha, alpha-dimethylbenzyl) diphenylamine.

Additive D is an antioxidant comprising zinc 2-mercaptotolumidazole.

Additive E is an accelerator comprising N,N′-1,3-Phenylene bismaleimide.

Additive F is a curative comprising dicumyl peroxide.

Polyethyleneimine has the physical properties as follows:

TABLE 1

| Physical properties | Value |
|---|---|
| Average weight molecular weight (Mw) | 25,000 g/mol |
| Viscosity at 20° C. | 100,000 mPa · s |
| Concentration (wt. %) | 99 |
| water | 1% |
| Pour point ° C. | −1 |
| Density at 20° C. (g/cm³) | 1.10 |
| pH (1% in water) | 10-12 |
| Ratio of primary:secondary: tertiary amine | 1:1.1:0.7 |
| Charge density | 17 meq¥g |

Equipment—bp Littleford Mixer

| | Model | | |
|---|---|---|---|
| | FM-130 | | |
| | HP | rpm | Type |
| Plows | 20 | 153 | Standard |
| Chopper | 20 | 3600 | Stars and Bars |

Preparation of Coated Aramid Pulp

Procedure

The blending operation is conducted in a 130-liter mixing vessel by bp Littleford. The FM-130 plowshare mixer is equipped with a variable-speed 20 HP (15 kW) motor, with a top speed of 153 rpm at 60 Hz. Standard plowshare mixing tools are installed. The chopper motor is also 20 HP, with a top speed of 3600 rpm. A “stars and bars” stack, consisting of alternating multipoint and 4-X blades, is installed on the chopper for these trials. The mixing jacket is heated using a steam loop.

A tank containing the 5 wt % Polyethyleneimine solution in water is placed directly on a scale, nitrogen is used to meter in the solution through a ¼ LNN-1 spray nozzle located on the mixers top port. The nozzle is oriented to spray and apply the solution directly on the material rather than the chamber walls or the horizontal shaft. Application rate is ¼ lb./min.

Aramid pulp (examples 1 to 4 in Table-2), is added into the plow shear mixer; the plows and chopper are then run simultaneously for the time specified in Table-2. The run is continued and once the fibrils are disentangled, polyethylenimine solution is added. The product temperature drops as the solution is applied. Vacuum is applied to the system when roughly one half of the solution has been sprayed onto the product. The spray rate slightly increases once vacuum-assisted drying begins due to the increased pressure differential. The drying process is continued for 45 minutes to 90 minutes, until the product is back up to temperature. The total batch time is 1.5 hours to 2 hours.

TABLE 2

| | | | | | | | | | | | | Drying | | |
|---|---|---|---|---|---|---|---|---|---|---|---|---|---|---|
| | Aramid | | | | Polyethyleneimine | | | | | | | Start | | |
| | pulp | | Disentangle | | solution injecting | | | Temperature (° C.) | | | | point | | |
| Example | amount | Chopper | Time | Plow | Amount | Time | Plow | | Jacket | Jacket | Vacuum | (lb. of | Time | Plow |
| no. | (lb) | rpm | (minute) | (rpm) | (lb.) | (minutes) | (rpm) | Product | in | out | (mm Hg) | solution) | (minute) | (rpm) |
| 1 | 5 | 1625 | 10 | 153 | 4 | 16 | 153 | 72 | 113 | 113 | 27.5 | 2.81 | 51 | 115 |
| 2 | 3.4 | 1625 | 10 | 153 | 2.7 | 10 | 153 | 75 | 121 | 120 | 27.0 | 1.33 | 66 | 153 |
| 3 | 5 | 1625 | 10 | 153 | 4 | 16 | 115 | 77 | 120 | 120 | 27.6 | 2.5 | 45 | 115 |
| 4 | 5 | 1625 | 10 | 153 | 4.3 | 16 | 153 | 68 | 122 | 121 | 26.5 | 2.5 | 92 | 115 |

Coated aramid pulp of Example 1 is compounded into ethylene propylene diene rubber (EPDM) V-Belt Compound. The amount and type of each component is indicated in Table 3 below with all values in parts per hundred (phr) rubber.

All of the components except for the accelerator and curative are first compounded for about 3 minutes in a conventional rubber mixer with a conventional mixing procedure to form a base material. This “first pass” mixing procedure is initiated at a starting temperature of 38° C. (100° F.) and a starting rotor speed of 65 to 75 RPM. This first-pass mixing procedure utilizes sweeps at 82° C. (180° F.), 93° C. (200° F.), and 110° C. (230° F.), with a dump at about 137° C. (280° F.).

Curative and accelerator are added to the coated aramid pulp (5 phr, 10 phr and 15 phr) and uncoated aramid pulp are then compounded for about 1.3 minutes at a lower temperature in a conventional rubber mixer with a conventional mixing procedure to form examples 5-7 and comparative example 1. This “final pass” mixing procedure is initiated at a starting temperature of 38° C. (100° F.) and a starting rotor speed of 65 to 75 RPM. This “first-pass” mixing procedure utilizes a single sweep at 82° C. (180° F.) with a dump at about 99° C. (210° F.).

Referring to Table 3 below, the amount and type of each component included in example 5 to 7 and Comparative example 1 is indicated with all values in parts per hundred (PHR) rubber, and the processing parameters utilized in the compounding process are set forth.

TABLE 3

| | | | | Com- |
|---|---|---|---|---|
| | Ex- | Ex- | Ex- | parative |
| | ample | ample | ample | example 1 |
| | 5 | 6 | 7 | Uncoated |
| Components | PHR | PHR | PHR | 15 PHR |
| Royalene 580-HT | 100 | 100 | 100 | 100 |
| Coated aramid pulp | 5 | 10 | 15 | — |
| Uncoated aramid | — | — | — | 15 |
| pulp | | | | |
| Filler A | 50 | 50 | 50 | 50 |
| Additive A | 15 | 15 | 15 | 15 |
| Additive B | 5 | 5 | 5 | 5 |
| Additive C | 1 | 1 | 1 | 1 |
| Additive D | 1.5 | 1.5 | 1.5 | 1.5 |
| Additive E | 1 | 1 | 1 | 1 |
| Additive F | 8 | 8 | 8 | 8 |
| Total | 186.50 | 191.50 | 196.50 | 196.50 |

First Pass Processing Notes
(Royalene 580-HT, coated aramid pulp, Filler A,
and Additives A, B, C, and D added)

| | | | | |
|---|---|---|---|---|
| Mix Time | 6.7 | 6.7 | 6.7 | 6.5 |
| Dump Temp. (° C.) | 133 | 138 | 137 | 137 |
| Integrated Power | 95 | 105 | 103 | 107 |
| (HP * min) | | | | |

Final Pass Processing Notes
(Additives E and F added)

| | | | | |
|---|---|---|---|---|
| Mix Time | 1.4 | 1.2 | 1.2 | 1.4 |
| Dump Temp. (° C.) | 99.4 | 99.0 | 99.0 | 99.4 |
| Integrated Power | 29 | 25 | 27 | 34 |
| (HP * min) | | | | |

Examples 5 to 7 and Comparative example 1 are tested for:
MDR Cure Data:

1. Tc90: The time it takes for a compound to reach 90 percent of its total state of cure or crosslinks.

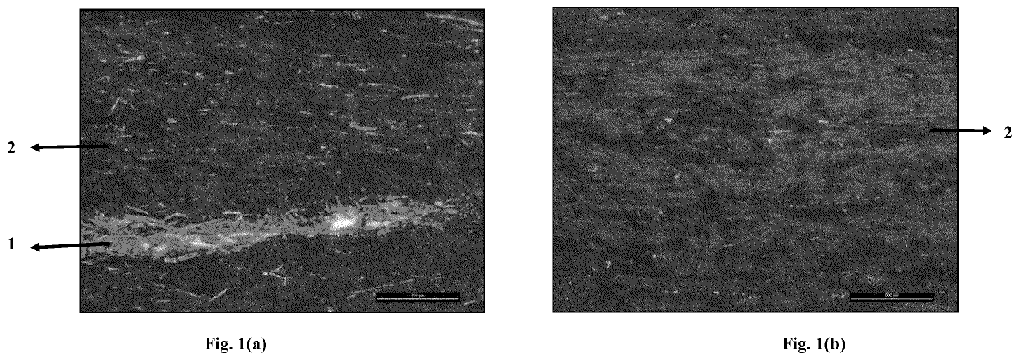

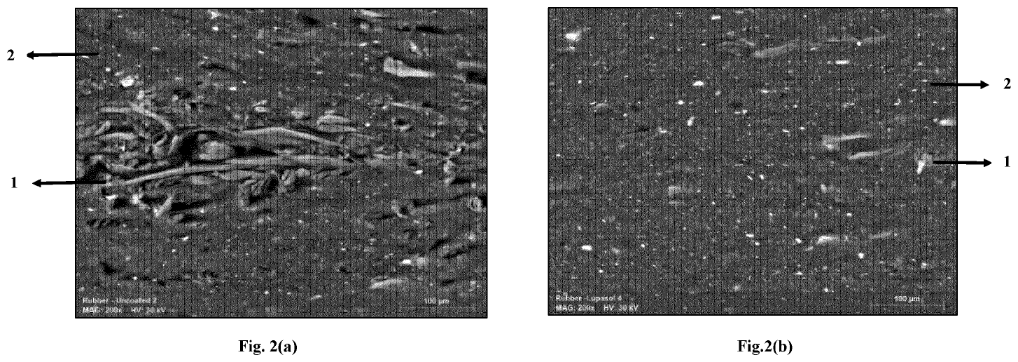

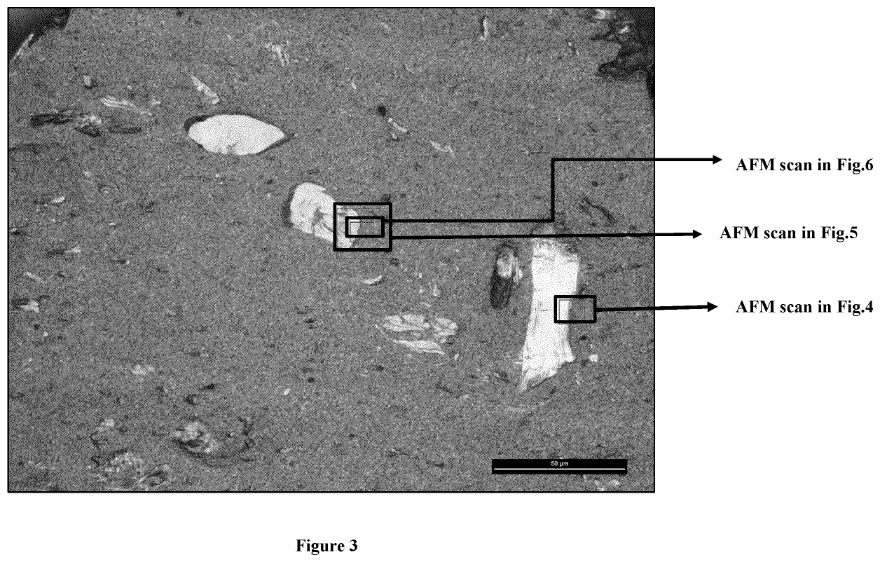

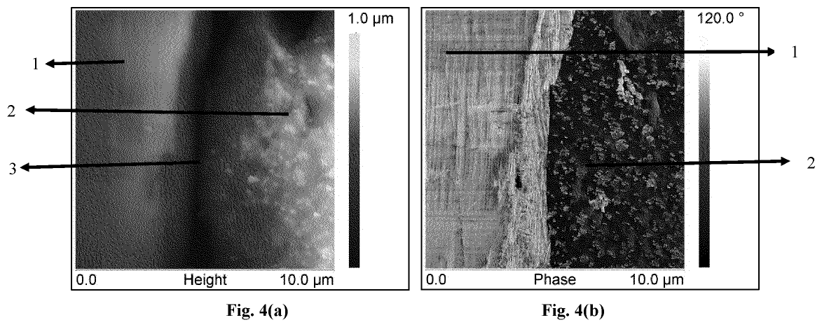

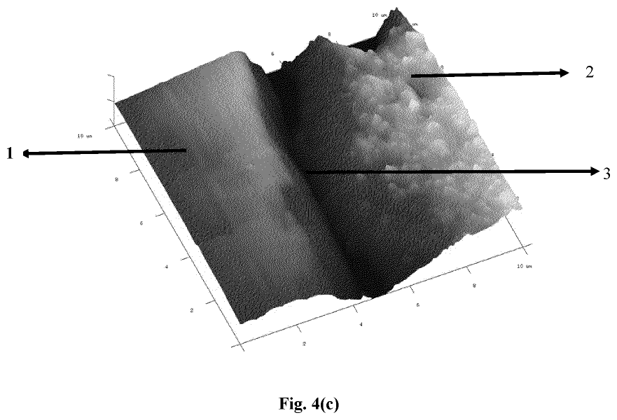

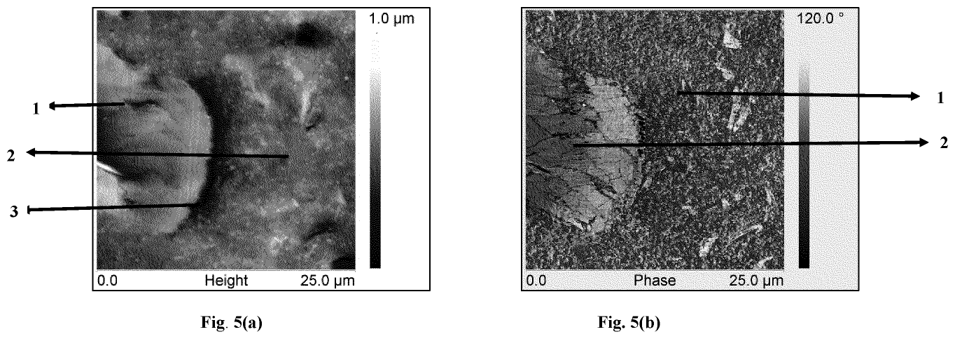

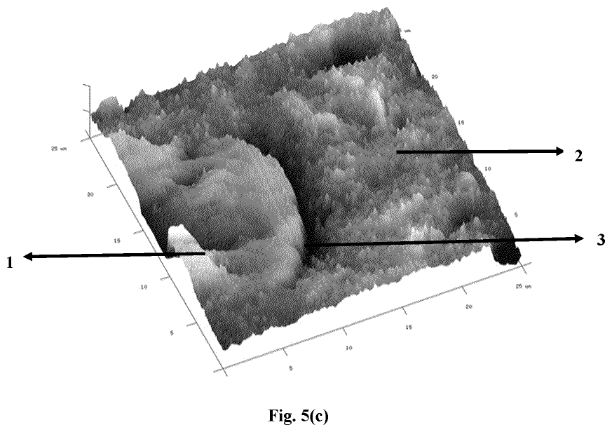

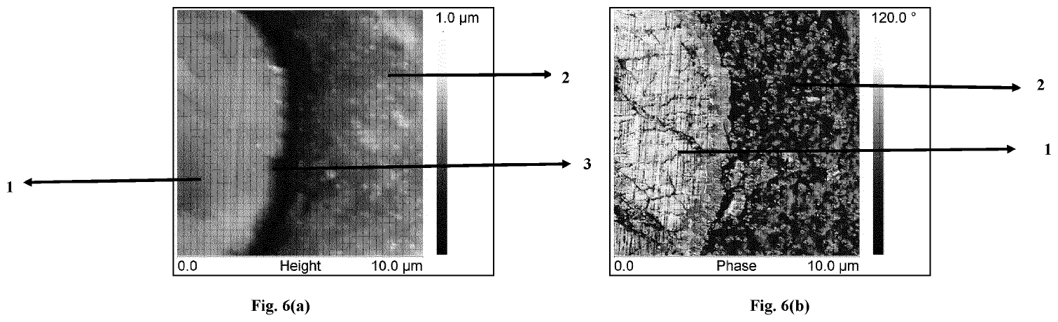

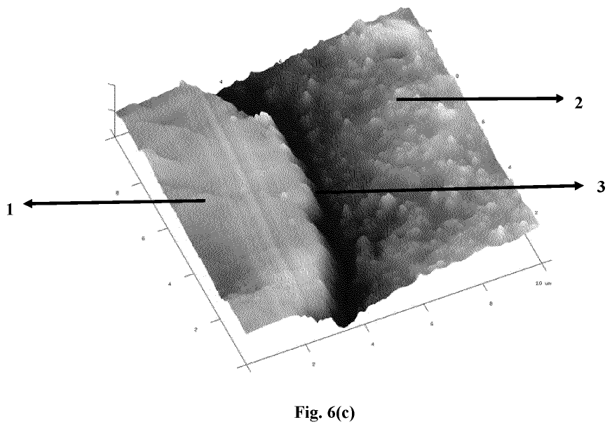

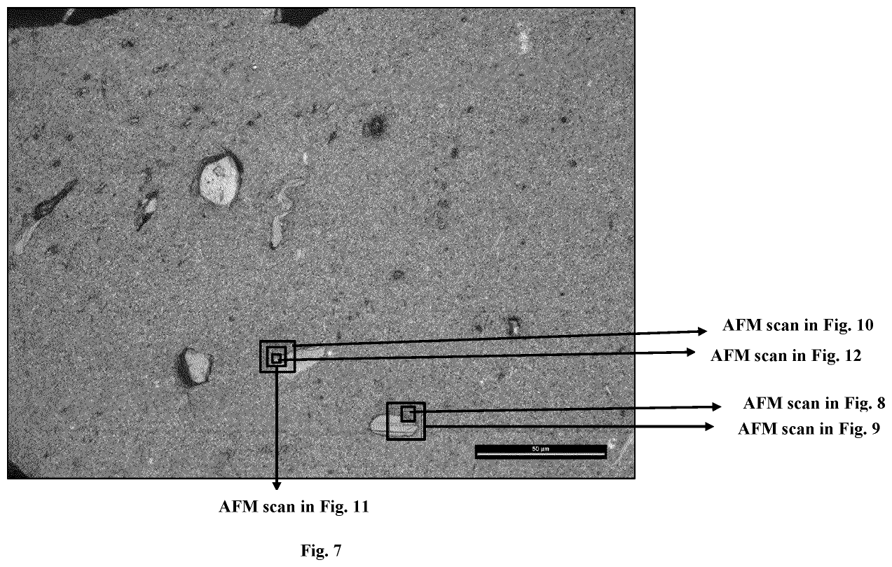

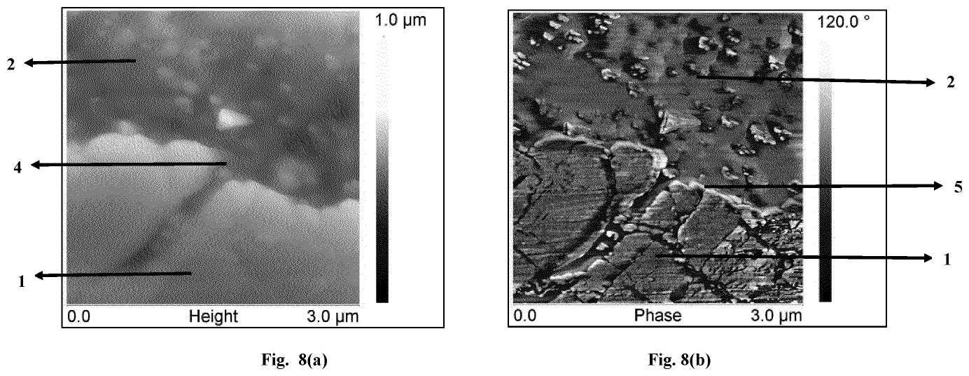

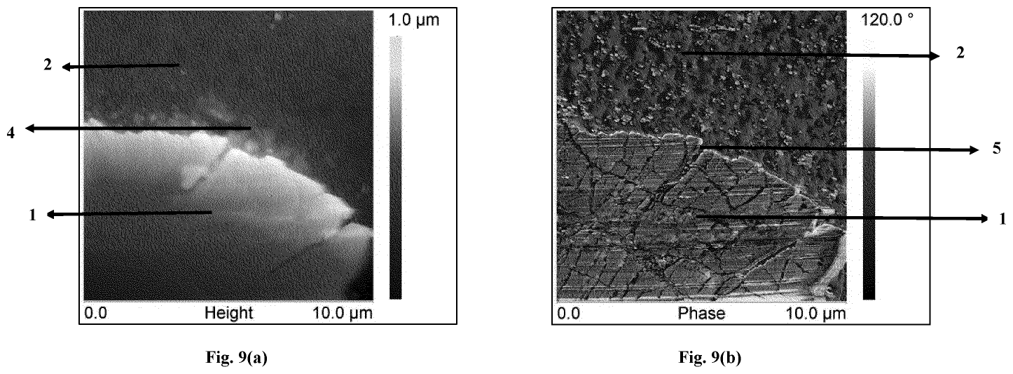

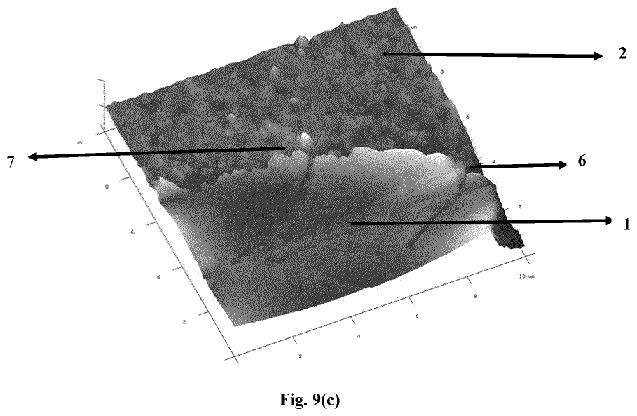

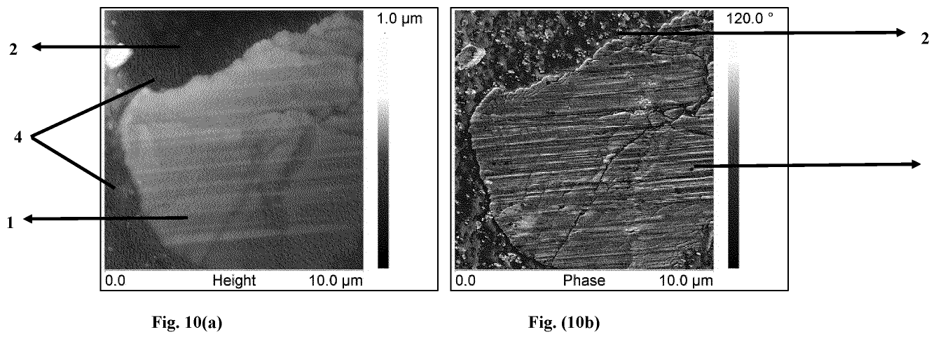

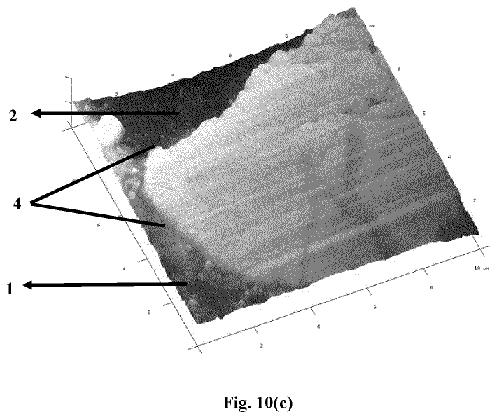

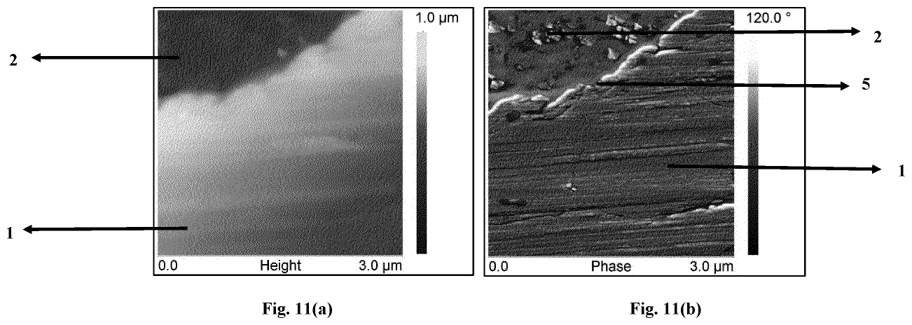

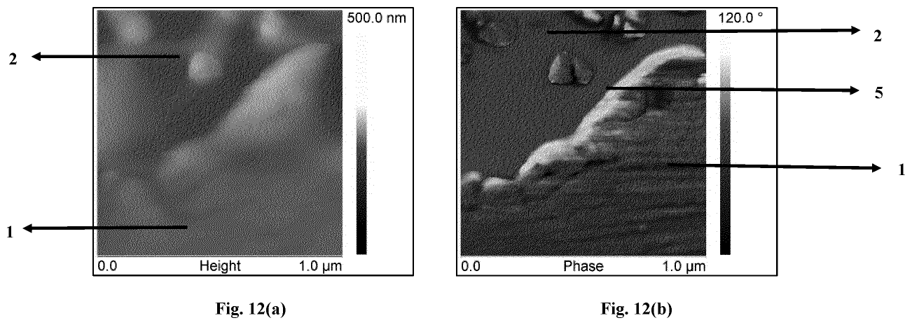

2. Ts1: The time it takes for the viscosity to rise 1 point over the Minimum Torque (ML) value. This is an indication of the time it takes for the compound to begin curing up at the specified temperature. Ts1 can indicate compound shelf life and stability and can help determine if you have enough time to injection or transfer mold. (ASTM D5289-12/TechPro RheoTECH MDR/170° C. (338° F.)/0.5° arc);
Physical Properties (ASTM D412, D2240)
1. Durometer: Measures the hardness of the compound. Higher means a harder compound (Shore A),
2. Tensile Strength at Break: The force a rubber compound can withstand while being stretched before breaking (ASTM D412-15a, D2240-15);
3. Elongation at Break: The length at the breaking point expressed as a percentage of its original length (ASTM D412-15a, D2240-15);
   Dynamic testing of Rubber, ASTM D5992 (Instrument: Metravib DMA 150 Dynamic Mechanical Analyzer, Test Mode: Tension, Temperature: 30° C., Frequency: 1 Hz, Strain: 0.05% to 50%)
1. Storage modulus E′: Also known as elastic modulus, is the resultant stress in phase with the applied strain in a sinusoidal deformation, divided by the strain. It is a measure of how elastic a compound is.
2. Loss Modulus, E″: Loss Modulus is the resultant stress component 90° out of phase with the applied strain in a sinusoidal deformation, divided by the strain. It is also known as the viscous modulus. It is a measure of how viscous a compound is.
3. Tan Delta: Tan Delta is calculated as E″ (Loss Modulus) divided by E′ (Storage Modulus). It is a measure of the ratio of the energy lost to the energy stored during a sinusoidal deformation. Higher Tan Delta usually means higher heat buildup and better damping.
4. Payne Effect: The Payne effect is the drop in E′ as the dynamic strain is increased. The Payne effect is attributed to the filler-filler interaction, the breaking and recovery of weak physical bonds linking adjacent filler particles.
5. Mullins Effect: The Mullins Effect is a measure of the dynamic stress-softening that is observed between the first and second strain sweeps due to the polymer-filler matrix being pulled apart during the first strain sweep and not having time to re-agglomerate.
Dispersion analysis: Using nSPEC 3D (Nanotronics nSpec 3D, Objective Used: 10×, Topography Scan Settings: ΔZ=0.5; Model=0.4)
Microscopy SEM
   Razor blades were used to cut fresh X-sections of each of the rubber plaque samples. The X-sections were imaged at 50× (FIG. 1) magnification using brightfield reflected polarized light and crossed polar. The razor-cut X-sections were then imaged by SEM using variable-pressure backscattered electron imaging (VP-BSE) mode, which shows image contrast based on differences in atomic number (Z), where higher-Z elements appear brighter. FIG. 2 (100×) shows images of the Uncoated and coated samples for comparison.
   Atomic Force Microscopy (AFM)
   The rubber plaques were cryo-ultramicrotomed (−100° C.) with a diamond knife to give a 100 nm smooth block face for TappingMode™ AFM characterization.

TappingMode™ AFM Height (topography) and Phase (viscoelasticity) images were done at room temperature (after the sample was brought from −100° C. to room temperature) at the interface between individual pulp fibers and the rubber matrix to compare adhesion at the interface.

The test results for MDR Cure Data (ASTM D5289, Montech Upgraded MDR-2000, 0.5° Arc/170° C. (338° F.)) are set forth in Table 4 below.

TABLE 4

| | | | | Comparative |
|---|---|---|---|---|
| | Example | Example | Example | example |
| | 5 | 6 | 7 | 1 |
| Minimum Torque | 1.72 | 2.10 | 2.66 | 2.47 |
| ML (lb-in) | | | | |
| Scorch Time, ts1 | 0.52 | 0.51 | 0.51 | 0.52 |
| (minutes) | | | | |
| Cure Time, t₉₀ | 6.46 | 6.45 | 6.88 | 5.58 |
| (minutes) | | | | |
| Maximum Torque | 16.70 | 18.99 | 21.81 | 23.00 |
| ML (lb-in) | | | | |

As seen in Table-4, samples with coated aramid pulp (examples 5 to 7) and uncoated comparative example (Comparative example 1) had similar Ts1 times, but the samples with coated aramid pulp had slightly longer tc90 times than the uncoated control batch.

The test results for the Physical Properties (ASTM 0412, 02240, Die C dumbells tested at 20 in/mmn) are set forth in Table 5 below.

TABLE 5

| | Example | Example | Example | Comparative |
|---|---|---|---|---|
| | 5 | 6 | 7 | example 1 |
| Durometer | 73 | 81 | 84 | 81 |
| (Shore A, | | | | |
| points) | | | | |
| Tensile | 1672 | 1273 | 1204 | 1155 |
| Strength at | (WG) | (WG) | (WG) | (WG) |
| Break (psi) | 1379 | 1166 | 1143 | 1044 |
| | (AG) | (AG) | (AG) | (AG) |
| Elongation | 286 | 218 | 126 | 152 |
| strain at | (WG) | (WG) | (WG) | (WG) |
| break (%) | 297 | 221 | 188 | 212 |
| | (AG) | (AG) | (AG) | (AG) |

As shown by the data in Table-5, the sample with 10 PHR coated aramid pulp (example 5) has similar durometer values as the batch with 15 phr uncoated aramid pulp (comparative example 1). The batch with only 5 phr of coated pulp (example 4) has slightly lower durometers while the batch with 15 phr of coated pulp (example 6) has slightly higher durometers.

The batches with 10 phr coated aramid pulp (example 5) and 15 phr of coated pulp (example 6) have similar with-grain (WG) & against-grain (AG) tensile strength at break when compared to the batch with 15 phr uncoated pulp (comparative example 1). The batches with only 5 phr of coated aramid pulp (example 4) has a much higher tensile values.

The test results for Dynamic testing of Rubber, ASTM D5992 (are set forth in Table 6 below.

TABLE 6

| | Example | Example | Example | Comparative |
|---|---|---|---|---|
| | 5 | 6 | 7 | example 1 |
| Storage modulus | 20 | 40 | 48 | 56 |
| E′ (MPa) | | | | |
| Loss Modulus, | 1.7 | 4.0 | 3.4 | 4.4 |
| E″ (MPa) | | | | |
| Tan Delta | 0.09 | 0.10 | 0.075 | 0.08 |
| Payne Effect | 13 | 27.5 | 28 | 37 |
| (MPa) | | | | |
| Mullins Effect | 14 | 39.5 | 48 | 13 |
| (MPa) | | | | |

The batch with 15 phr of coated pulp (example 6) has a lower tan delta than the batch with 15 phr uncoated pulp (comparative example 1). This implies that the batch with 15 phr of coated pulp (example 6) would likely have lower heat buildup which equates to better dynamic. The less the heat, the less is oxidative and heat degradation and hence there is a longer service life.

Payne effect value indicates how well the sample is dispersed in rubber. The lower the value of Payne effect, better is the dispersion. Compared to the batch with uncoated aramid pulp, the value of Payne effect is lower for all the 3 batches containing coated aramid pulp.

The Mullins Effect is a measure of the dynamic stress-softening that is observed between the first and second strain sweeps due to the polymer-filler matrix being pulled apart during the first strain sweep and not having time to re-agglomerate. A higher Mullins effect for the batches with coated aramid pulp indicate a better interaction between the pulp and the polymer matrix.

The batches of examples 5 to 7 and comparative example-1 are cut and a cross section analysis is performed on a Nanotronics nSpec 3D at the following settings:
Objective Used: 10×
Topography Scan Settings: ΔZ=0.5; Model=0.4
3D Model Flattened After Scan
Peak Threshold: 6
Peak Tolerance: 0
Against the Grain (AG): the ends of the fibers can be seen
With the Grain (WG): the length/side of the fibers can be seen
The colored images are the 3D models of the surface.

The values of surface analysis parameters are disclosed in Table-7. Sa is arithmetical mean roughness value (area): The arithmetical average of the absolute values of the profile height deviations from the mean surface plane, recorded within the evaluation area.

Sq is the root mean square deviation (area). It is the root mean square average of the profile height deviations from the mean surface plane, recorded within the evaluation area. It is equivalent to the standard deviation of heights.

TABLE 7

| | Example | Example | Example | Comparative |
|---|---|---|---|---|
| | 5 | 6 | 7 | example 1 |
| Average volume of | 3439.9 | 4956.4 | 5567.3 | 7980.8 |
| Peaks + Valleys, μm³ | | | | |
| No. of Peaks + Valleys | 219 | 170 | 209 | 186 |
| Sa (Surface | 4.59 | 3.78 | 4.28 | 5.18 |
| Roughness), μm | | | | |
| Sq (Roughness | 99.92 | 120.82 | 97.56 | 69.81 |
| Deviation), μm | | | | |
| Dispersion (%) | 3.00 | 3.00 | 3.00 | 3.00 |

A lower value of both Sa and Sq for the batches of examples 5 to 7 represent a smoother surface.

1. Aramid pulp comprising a plurality of fibrils, said fibrils having a coating of polyalkyleneimine disposed thereon.

2. The coated aramid pulp according to claim 1, wherein the aramid pulp has a weight average molecular weight of 10,000 g/mol to 40,000 g/mol.

3. The coated aramid pulp according to claim 1, wherein the polyalkyleneimine has primary amines, secondary amines and tertiary amines in a weight ratio of 1:0.9:0.5 to 1:1.1:0.7.

4. The coated aramid pulp according to claim 1, wherein the polyalkyleneimine is polyethyleneimine.

5. The coated aramid pulp according to claim 4, wherein the polyethyleneimine has a weight average molecular weight of 800 g/mole to 2,000,000 g/mole.

6. The coated aramid pulp according to claim 4, wherein the polyethyleneimine has a nitrogen to carbon ratio of 1:2.

7. A method of coating aramid pulp comprising a plurality of fibrils, said method comprising
(a) separating the plurality of fibrils to disentangle the fibrils;
(b) providing an aqueous solution of a polyalkyleneimine;
(c) adding the aqueous solution of step (b) to the plurality of fibrils of step (a); and
(d) coating the plurality of fibrils with the polyalkyleneimine to form a coated aramid pulp.

8. The method according to claim 7, further comprising a step (e) of drying the coated aramid pulp.

9. The method according to claim 7, wherein step (a) is carried out in a mixer.

10. The method according to claim 9, wherein the mixer is a plough shear mixer.

11. The method according to claim 7, wherein the aqueous solution comprises the polyethyleneimine in a range of 1% to 20% by weight based on the total weight of the aqueous solution.

12. The method according to claim 8, wherein step (e) drying is carried out at a temperature of 50° C. to 150° C.

13. A rubber composition, based on parts by weight per 100 parts by weight rubber (phr), comprising:
(a) 1 to 25 phr of the coated aramid pulp according to claim 1; and
(b) rubber
wherein said fibrils are dispersed in said rubber.

14. The rubber composition according to claim 13, wherein the rubber is selected from natural rubber, synthetic rubber, and blends thereof.

15. The rubber composition according to claim 13, wherein the amount of coated aramid pulp is in the range of 3 phr to 20 phr.

16. The rubber composition according to claim 13, wherein the amount of coated aramid pulp is in the range of 5 phr to 15 phr.

17. The rubber composition according to claim 13, further comprising at least one additive.

18. The rubber composition according to claim 17, wherein the at least one additive is selected from the group consisting of curatives, accelerants, anti-oxidants, retarders, processing additives, plasticizers, chain terminators, adhesion promoters, flame retardants, dyes, ultraviolet light stabilizers, fillers, acidifiers, and catalysts.

19. A method for preparing a rubber composition comprising:
(i) providing the coated aramid pulp according to claim 1;
(ii) dispersing the coated fibrils of the aramid pulp of step (i) into rubber to form a rubber mixture;
(iii) combining the rubber mixture of step (ii) with at least one curative agent; and
(iv) curing the rubber mixture.

20. The method according to claim 19, wherein the amount of coated aramid pulp is in the range of 5 phr to 15 phr.

21. The method according to claim 19, wherein the curative agent is selected from the group consisting of sulfur, peroxide, metallic oxide, urethane crosslinkers, acetoxysilane, and mixtures thereof.

22. (canceled)

23. (canceled)

24. A conveyor belt, power transmission belt, seals, gaskets, tires or stator pump components comprising the composition according to claim 13.
